(19) United States
(12) Patent Application Publication
(10) Pub. No.: US 2025/0035465 A1
(43) Pub. Date: Jan. 30, 2025

(54) METHOD FOR DETERMINING A RELATIVE POSITION INDICATION IN A TRACK

(71) Applicant: TRACK MACHINES CONNECTED GESELLSCHAFT M.B.H., Linz (AT)

(72) Inventors: Benjamin STUNTNER, Ansfelden (AT); Daniel HARTL, Linz (AT)

(73) Assignee: TRACK MACHINES CONNECTED GESELLSCHAFT M.B.H., Linz (AT)

(21) Appl. No.: 18/715,848

(22) PCT Filed: Nov. 22, 2022
(86) PCT No.: PCT/EP2022/082875

§ 371 Date: Jun. 3, 2024

(30) Foreign Application Priority Data
Dec. 1, 2021 (AT) A 50963/2021

(51) Int. Cl. G01C 22/00; G06T 7/73

(52) U.S. Cl. CPC G01C 22/00; G06T 7/74; G06T 2207/20101; G06T 2207/30252

(57) ABSTRACT

Method for determining relative position indication of a position in a track. Measured values of a plurality of objects in track construction are determined by a measuring device, which measured values describe at least one property of an object of the plurality of objects. The measured values are compared with reference measured values or a reference measurement range, or a measurement pattern of the measured values is compared with a reference measurement pattern of a selected reference object to select a single object from the plurality of objects, determining a degree of similarity between the selected object and the reference object, which reference object is stored as an immovable reference object in the database, which degree of similarity is determined computationally and is indicated by a numerical value. The position in the track is indicated by a vectorial distance between an origin point arranged at the object and the position.

### CROSS-REFERENCE TO RELATED APPLICATIONS

The present application is a national phase application of PCT Application No. PCT/EP2022/082875, filed Nov. 22, 2022, entitled “METHOD FOR DETERMINING A RELATIVE POSITION INDICATION IN A TRACK”, which claims the benefit of Austrian Patent Application No. 50963/2021, filed Dec. 1, 2021, each of which is incorporated by reference in its entirety.

### BACKGROUND OF THE INVENTION

### 1. Field of the Invention

The invention relates to a method of relative localization of a position on a track with reference to a detectable object.

### 2. Description of the Related Art

Localization on the track may be, for example, via GPS or GARMIN. Application of these methods, however, is limited to those parts of the track where the respective data is retrieved.

Localization may also be through the application of measuring methods which determine properties of a single rail or the rails following a reference point. Both in contactless measuring methods and in measuring methods which are based on contact between a sensor and a single rail or the rails, such method of localization is subject to the temporary properties of the rail. A rail made of iron, for example, is subject to an extension in length due to a change in temperature. The change in length of an iron rail caused by the change in temperature may be, for example, 1.2 meters in case of a 10° C. change in temperature and a rail length of altogether 10,000.0 meters (traveled length during measurement). Even a layperson will appreciate that no sufficiently exact localization can be done based on rail length as a property of the rail when such changes in the length of the rail occur due to its physical properties.

Particularly in measuring methods which are based on mechanical contact between the sensor and the rail or rails, mechanical contact is a variable factor influencing the accuracy of localization. When measuring with a measuring wheel rolling on the rail, there is always mechanical slippage between the measuring wheel and the rail. Also, there is mechanical abrasion on the rolling surface of the measuring wheel, which abrasion reduces the diameter of the measuring wheel. Accuracy when measuring a length of a rail with a contact-based measuring device is therefore always dependent on the length of the distance measured.

DE102010047580 relates to a method of determining information, in which the sleeper distance between two sleepers and a pattern thereof over a measured distance is proposed as a measure for the condition of the track distance and also for coding the sleepers. In DE102010047580 [0020], said coding of sleepers is further regarded as an alternative to kilometrage on kilometre stones. The localization proposed in DE102010047580 is limited to information in the proximity of a given sleeper.

WO200166401 discloses a method of localizing a rail-bound vehicle, in which localization is conducted by intercalating between detected objects in the track area and in consideration of the vehicle speed.

WO2002058984 is part of the patent family of DE10104946. WO2002058984 discloses a method of localization, in which saved data about a track segment is retrieved and compared to current data about a track segment. It is essentially a comparison of characteristics of saved data and current data for localization. No reference to determining an object with certain properties or counting objects with certain properties in traveling direction is given in WO2002058984.

US2012274772 describes a method of determining a position of a rail vehicle, in which a distance between a known position of, for example, a sleeper to the rail vehicle is measured.

WO2015113678 discloses a method of determining the position of a vehicle, in which a sequence of objects is recorded using a camera and the one position in a map corresponding to the position of the vehicle is determined based on the sequence of the objects on the map.

DE1952104 describes a method of determining a position by means of ‘map matching’.

It is disclosed in the description below that sleepers may be used as selected objects. Detection of sleepers is also addressed in AT411277 and AT509481, for example.

The invention discussed in the following has the object of providing an easily performable method of localizing a position on a track, which method offers high accuracy. In particular, it is intended that the accuracy of the method is not subject to any temporary properties or influences.

The inventive method is exemplified based on operation of a measuring vehicle which is moved on the track. The measuring vehicle may be a rail-bound vehicle. However, the invention is not limited on the mere use of a rail-bound or earth-bound measuring vehicle. In an equivalent manner, a user may also use a drone as an airborne vehicle or another earth-bound vehicle.

The question what type of measuring vehicle is used to perform the inventive method described in the following essentially equals the question in what form the measuring device arranged on the measuring vehicle is to be moved relative to the track.

Measuring devices for determining measurement values as common in prior art are known, which measurement values describe a condition or properties of a track. The invention builds on the use of such measuring devices known in prior art. In the context of the disclosure of the inventive method, measuring devices are mentioned by way of example. The measuring devices may be based on the contactless determination of measurement values or on establishing contact between a sensor and the object to determine measurement values. Said measuring device may be a camera having a camera sensor, for example.

A property of an object may be, for example and therefore in a non-limiting manner, a color, a surface condition such as, for example and therefore in a non-limiting manner, a surface structure, a size, a dimension, a mark, or a tag of the object. A tag may be, for example, a number assigned to the object. Methods of assigning measurement values to object classes are known in prior art, including classification of the object. The above measurement values describing a property are suitable for performing such assignation to an object class and classification of an object.

A property may also be a code which is suitable for clearly and unequivocally identifying an object or object group from a plurality of objects. A code may be a label clearly visible to a person. A code may also be a label which can be read out only with a suitable device. For example, rails have a rail number or fabrication number as a code. The above measuring device may be suitable for reading out a code and generating measurement values via said code.

### SUMMARY OF THE INVENTION

According to the invention, the above task can be achieved by the measurement values by matching the measurement values with reference measurement values or a reference measuring area or a measurement pattern of the measurement values with a reference measurement pattern of a selected reference object to select a single selected object from the plurality of objects, thereby optionally determining a similarity measure between the selected object and the reference object, which reference measurement values/reference measuring area of the reference object are/is deposited in a database, which reference object is deposited in the database as an immobile reference object, which similarity measure is determined by calculation and which similarity measure can be indicated by a numerical value, and the position on the track is indicated by a vectorial distance between a point of origin arranged on the object and the position, which point of origin has a property determinable by the measuring device through measurement values, which property is different from first points adjacent to the point of origin, or which point of origin is defined by geometrical conditions with respect to second points, which second points are different from points adjacent to said second points.

The term measurement pattern is known based on common teachings. It should be added that a measurement pattern may mean, for example, a representation of the measurement values as a series of measurement values and/or a function regarding a spatial dimension and/or time.

According to the invention, localization on the track may be such that a single selected object is defined by a reference object. The measuring car is moved on the track, while a plurality of objects is detected using the measuring device. The one selected object defined by the reference object is searched for in the plurality of objects, wherein the measuring vehicle is actually or virtually moved on the track during said search. If the selected object is found, the vectorial distance between a point of origin on said selected object and the position is then determined.

The distance may be zero or greater than zero or smaller than zero. A distance greater than zero may be, for example, a distance measured in traveling direction. A distance smaller than zero may be, for example, a distance measured against traveling direction.

The selected object has at least one unique property with respect to the plurality of objects. The unique property of the selected object is different from the property of the plurality of objects. The selected object may have multiple unique properties, wherein a property in itself alone or combined with another property may be unique with respect to a property or properties of the plurality of objects.

Definition of the selected object is through measurement values or reference measurement values, which reference measurement values are exhibited by the reference object; the measurement values are matched with the reference measurement values by applying current teachings. The user selects a reference object with reference measurement values which allow the detection of a non-relocatably seated selected object by comparison with the measurement values.

In the context of the disclosure of the invention, an object is regarded as non-relocatable if said object does not undergo a change in position in general and replacement or torsion in particular under a load typical in the railway industry.

According to the invention, this can be achieved by matching the measurement values with a reference measurement value or reference measuring area of a reference object group or a measurement pattern of the measurement values with a reference measurement pattern of the reference measurement values to select selected objects from the plurality of objects, thereby optionally determining a similarity measure between a selected object among the selected object and the reference objects, which reference measurement values/reference measuring area of the reference object group is/are deposited in a database,

which reference object is deposited in the database as an immobile reference object, which similarity measure is determined by calculation and which similarity measure can be indicated by a numerical value,

which selected objects have at least one similar property described by a measurement value, and

a number n, with n=1, 2, 3 . . . , of the selected objects is determined on a distance traveled from the starting point by the measuring vehicle,

wherein the position is indicated by a vectorial distance between a point of origin and the position,

which point of origin is arranged on the n-th selected object among a series of selected objects and

which point of origin has a property determinable by the measuring device through measurement values, which property is different from first points adjacent to the point of origin, or

which point of origin is defined by geometrical conditions with respect to second points, which second points are different from points adjacent to said second points.

The last selected object in a series of selected objects as seen in traveling direction is the n-th selected object when counting from a starting point.

The measuring device detects a plurality of objects when performing the inventive method using a measuring device arranged above the track. Among said plurality of objects, a group may be defined as selected objects. The selected objects of this group are characterized by at least one common property or by a property to which the selected objects of the group have similar properties. The at least one property of the selected object is a unique property with respect to a plurality of objects.

The measuring vehicle is actually or virtually moved on the track from a starting point. The number n of selected objects in this group is determined beginning at the starting point. The point of origin is defined by the n-th selected object as seen in traveling direction. The point of origin may be on the last selected object or have a position of origin relative to the n-th selected object.

A vectorial distance between the point of origin and the position is determined from the last or n-th selected object of this group. The distance may be zero or greater than zero or smaller than zero. A distance greater than zero may be, for example, a distance measured in traveling direction. A distance smaller than zero may be, for example, a distance measured against traveling direction.

The position is thus indicated by the number n of selected objects from a starting point and by the vectorial distance.

The n-th selected object may be the last selected object in the series of detected selected objects as seen in traveling direction.

The above description includes the feature of actually or virtually displacing the measuring car on the track.

A real displacement of the measuring car may be, for example, when a track maintenance machine is moved to the position. An application of the inventive method may be to control a track-bound vehicle or machine while approaching the position. A real displacement may also be when the position on the track is localized by applying the inventive method.

A virtual displacement of the measuring car may occur, for example, when planning a project for repairing a track in the position.

For example and thus in a non-limiting manner, the track may have a discontinuity in the position mentioned. It is the object of this invention to localize a such discontinuity with sufficient accuracy and as simple means as possible.

The inventors believe that finding a selected object among the plurality of objects is a method performable with simple means. Also, counting the selected objects beginning at a reference point constitutes a method performable with simple means. It is further noted that measuring a distance between two points, in this case measuring a vectorial distance between the point of origin and the position, constitutes a method which is performable with simple means.

The inventive method may allow moving the measuring car to the selected object having the point of origin at high speed, since no special measuring requirements occur before the selected object having the point of origin.

Specification regarding a vectorial distance includes at least distance information and directional information. Distance specification is a numerical value in this case. Directional specification is information as to the direction in which the distance is measured or to be measured. Directional specification may be, for example, an instruction to measure in traveling direction or transversely to the same.

The above description includes the feature of point of origin. The inventive method may be interpreted in the sense that a local coordinate system is generated on the one selected object or on the last selected object of the series, which local coordinate system has its origin in the point of origin on the one selected object or on the last selected object of the series. It is for this reason that the term ‘point of origin’ has been chosen. The local coordinate system may be one-, two-, three- or four-dimensional (spatial localization including a time component).

In the simplest case, the local coordinate system is linked to a global coordinate system only through the presence of the one selected object or through the number of selected objects in a traveled distance with a traveling direction from the point of origin. The point of origin from which the number of selected objects is determined is preferably localized in a global coordinate system via a reference point.

The above description includes the feature of immobile selected objects. In an advantageous manner, the user chooses selected objects which do not change their position in the global coordinate system due to environmental influences or stress. This includes the reference object being deposited in the database as a non-relocatable object. Depositing the reference object in the database as a non-relocatable object may also include information as to when the non-relocatability and/or the correct layout of the object has been determined.

The inventive method provides that the point of origin be arranged on a non-relocatable selected point. This has the technical effect that the position relative to said point of origin and thus also in a global coordinate system can be localized over an extended period of time. The description below includes localization via the inventive method at a first time and at a subsequent second time. The first time may be a time at which the position is localized with a measuring vehicle. The second time may be a time at which a maintenance device is moved to the position. The time span between the first time and the second time may be regarded as an extended period of time.

The inventive method allows localization in history or data-based localization documenting the time course. The data may include information on assigning an object or the selected object with respect to a group. The data may include vectorial distance data. Said data may be linked to a time value.

The data includes a sufficiently accurate description of the selected object on which the point of origin is arranged. A description of the selected object that is sufficiently accurate in the sense of the inventive method may be achieved through the reference measurement values describing the unique properties. In a case where the second embodiment of the inventive method is applied, the sufficiently accurate description of the n-th selected object may further be achieved through the number n.

The data further includes information on a vectorial distance between the point of origin and the position.

The data may include temporal information on the localization. The data may include attributes regarding the measuring device. The data may include attributes regarding environmental properties during localization.

The disclosure of the invention mentions the localization of the position several times for localization of a discontinuity in a rail. The inventive method also allows localizing the position at a first time and at a second time. A comparison of first data, which describes the relative localization of the position at the first time, and of second data, which describes the relative localization of the position at the second time, may be added to the inventive method.

When determining a number n>1 of selected objects, it is sufficient that the last or n-th selected object in the series does not change its position. Merely the presence of the other selected objects must not be changed.

The inventive method is characterized by robustness vis-à-vis influences and change. This is in part achieved by determining not a chain of vectorial distances, associated with a chain of errors, but a single vectorial distance between the point of origin and the position. The information (number, unique property) of the selected object on which the point of origin is defined is robust since this information does not include any localization.

The point of origin may have a property which may be describable via the measurement values and thus determinable via the measurement values. Regarding the property, the point of origin is different from first points adjacent to the point of origin. In comparison to said first points, the point of origin has at least one unique property. Preferably, the measuring device for determining the one measurement values describing a property of the selected object and measuring device for determining the property of the point of origin are the same measuring device. Solutions deviating therefrom, such as the use of different measuring devices, constitute equivalent or rather worse or more laborious solutions.

It can thereby be achieved that no mark of the point of origin needs to be placed on the selected object. A selected object as it typically occurs in nature may be used to localize the position. The invention disclosed herein is not limited to the provision of a mark.

The inventive method can also include the step of placing a mark on the n-th selected object.

The point of origin may be defined by geometrical conditions with respect to two points, which are different from points adjacent to said second points. This also achieves that the inventive method is not limited to the provision of a mark of the point of origin. The point of origin may be, for example, a division point of a straight connecting line between the points.

The point of origin may be defined by the orientation of a straight line extending through the position to the n-th selected object or to an axis of the n-th selected object. The point of origin may be, for example, a point of an axis of the selected object, in which point a straight line extending through the position intersects the axis of the selected object at a defined angle. The angle may be, for example and in a non-limiting manner, 90 degrees.

The mentioned axis of the selected object may be defined by the above points with unique properties with respect to adjacent second points. The mentioned axis may be defined by the geometrical shape of the selected object, so that the mentioned axis may be, by way of example and not limitation, the central axis of a basic layout.

The above description mentions the feature of determining the similarity measure by calculation. The similarity measure is indicated by a numerical value in the inventive method.

A potential application of the inventive method may be to determine a position on a track at a first time. The track may have in the position a discontinuity such as, for example and thus in a non-limiting manner, a break in a rail.

At a second time, which is later than the first time, the rail may be repaired. It is entirely possible that the track including the rail and in particular the selected objects have undergone change between the first time and the second time, which change affects the inventive method partly in the form of a different similarity measure. This change of the track between the first time and the second time may require the localization of the repair vehicle to be simulated at the second time.

Said localization of the repair vehicle at the second time may be done using measurement values which have been generated shortly before the second time. The measurement values may be generated with a vehicle having a measuring device, for example, which vehicle can be moved at a higher speed than the repair vehicle one the track.

The feature of determined similarity measure, in particular by calculation, has the advantage of enabling the inventive method to be also performed virtually to simulate a planned project to be later conducted in actuality. Such simulation may be useful and required in particular when the localization of the discontinuity at the first time is done using a first measuring device and the localization of the repair vehicle at the second time is done using a second measuring device, with the first measuring device being different from the second measuring device. Each measuring device has its own measuring accuracy. A difference in measuring accuracy appears in particular when different measuring devices are arranged on different vehicles with different functions at different environmental influences. The similarity measure determined by calculation and the option of simulation allows recreating the localization by applying the inventive method.

The inventive method may be characterized in that the selected object(s) is/are a sleeper or fastening means or a mark.

The inventive method allows the use of objects typically occurring on a track as selected objects.

A sleeper as a selected object may be non-relocatably mounted in a bed. A rail installed in a ballast bed is regarded as non-relocatably mounted in the context of this method.

Further, the fastening device for attaching a rail to a sleeper may be selected as a selected object. Since the sleeper is regarded as non-relocatably mounted, a fastening element non-relocatably attached to the sleeper is regarded as equally non-relocatable. While a sleeper constitutes a planar element on which the point of origin is to be defined by special information, the fastening element or in particular a screw of the fastening element constitutes a point-shaped construct when seen from above and thus in layout, in which point-shaped construct the point of origin can be defined without further information. In this case, the point of origin defined by the screw will also be different from the first points adjacent to the screw.

A sleeper or other element of the track body may have a mark. For example, a sleeper may include a code as a mark for uniquely identifying a sleeper. A such mark may be used as a selected object in performing the inventive method.

As explained above, the inventive method is based on object detection, for which methods of prior art may be applied. Since the object detection may be problematic in particular with regard to a temporal change of the object to be detected, a person of skill in the art will preferably choose an object or multiple objects which are preferably not subjected to temporal change. While a sleeper may be partly covered by the track ballast, this does not affect the appearance of a vertically oriented screw of a fastening unit.

The inventive method may be characterized in that the point of origin lies on a central axis of the track.

A point of origin lying on the central axis is a point that can be uniquely defined; such point of origin is not subjected to any special influence, since the central axis of a track can be defined by a plurality of reference points stable against influences. For example, the central axis may be defined by the middle distance between the screws of the fastening device.

Defining the point of origin as a point on the central axis of a track has the effect of the sinusoidal trajectory of the measuring car having no influence on the inventive method. Further, the influence of traveling through bends on the inventive method may be reduced.

The inventive method may be characterized in that the position is a position on a rail and the vectorial distance comprises distance information which is measured in parallel with the rail.

Distance information along a rail may be measured using a measuring wheel. For example, when a sleeper is selected as a selected object, it may be assumed that a position is located between two sleepers. Since the typical distance between two sleepers is about 65.0 centimetres, any distance in the direction of the rail to be measured using the measuring wheel will be so small that slippage and/or abrasion have no influence. Also, the mentioned longitudinal change in length of a rail following a change in temperature is negligible.

The inventive method may be characterized in that starting point lies at the intersection between the central axis and a straight line, which straight line extends through a reference point and has an orientation perpendicular to the central axis.

A railway network includes reference points, which reference points are localized in a global coordinate system. The above description is a potential positional relationship of the starting point to a reference point.

The inventive method may be characterized in that the distance from the starting point to the selected object, which has the similarity measure with the reference object, or to the n-th selected object, which has the similarity measure with the reference object, is determined.

By determining the length of the distance, another parameter for finding the one selected object when moving the measuring vehicle on the track is created.

In this description of the inventive method, repeated mention is made of the sleeper defined by the unique feature as a selected object or the n-th sleeper as a selected object. Typically the sleepers on a track have a distance of 65.0 centimetres. The approximate length of the distance from the starting point to the n-th sleeper can be determined by counting the sleepers as selected objects.

The inventive method may be characterized in that the similarity measure lies in a similarity area defined by the user.

The user may choose a similarity area to accommodate for the above change of the track or the different accuracies of the measuring devices in a simulation. However, it is by no means a necessary requirement for performing a simulation to set up similarity areas.

The similarity area to be applied to the first time may represent a more rigid criterium, such as a higher matching value, than the similarity area to be applied to the second time.

The inventive method may be characterized in that other properties, determinable using other measuring devices, of the single selected object or of the last or n-th selected object in the series are stored in a database.

The inventive method may be characterized in that the measurement values are determined using a camera or using a rotation scanner or an eddy current sensor or using a ground-penetrating radar (GPR) or using RFID as a measuring device.

The camera may be a camera suitable for generating image data, which image data is suitable as a basis for data processing using AI etc. The camera may be a camera suitable for reading out codes or marks. Preferably, the camera delivers high-resolution image data, based on which the mentioned tasks can be fulfilled.

Such measuring devices are based on contactless measuring methods. The inventive method can also be performed with a measuring device based on contact. A such measuring device may include a mechanical adjusting device such as a gear, which adjusting device conducts a measurable movement when in contact with the selected object.

The mentioned measuring devices as typically installed on measuring cars. The inventive method can thus be performed with conventional measuring cars.

Regardless of the type of measurement, such as contact-based or contactless, for example, at least one measuring device may be provided for each of the left rail and the right rail. For example, the measuring area of a left measuring device is targeted to an area around the left rail. For example, the measuring area of a right measuring device is targeted to an area around the right rail. Such arrangement of measuring devices allows, among other things, determining a position of the selected objects with respect to one another.

Multiple measuring devices can be employed for detecting one selected object. The results of detecting the selected objects using the individual measuring devices may be matched.

The inventive method may be characterized in that the vectorial distance (a) is determined using an odometer wheel or a camera.

The camera for determining the vectorial distance may also be the camera serving as a measuring device.

### BRIEF DESCRIPTION OF THE DRAWINGS

The invention is additionally explained based on the following embodiments represented in the Figures:

FIG. 1: shows a potential embodiment of the inventive method for localizing a position,

FIG. 2: shows another potential embodiment of the inventive method for localizing a position,

FIG. 3: shows a potential embodiment of a device for performing the inventive method,

FIG. 4: shows an image out of image data, which image data is generated using a camera as a measuring device,

FIG. 5: illustrates another possible way of applying the inventive method, and

FIG. 6: illustrates potential starting points and points of origin using the example of a switch.

### DETAILED DESCRIPTION

The embodiments shown in the Figures merely show possible embodiments, while it should be noted at this point that the invention is not limited to those specially depicted variant embodiments thereof but combinations of the individual variant embodiments among each other and a combination of an embodiment with the general description given above are also possible. Such further possible combinations do not need to be expressly mentioned since such further possible combinations are within the skill of a person of skill in the relevant art based on the teachings on technical action by the present invention.

The scope of protection is defined by the claims. However, the description and the drawings have to be consulted in interpreting the claims. Individual features or combinations of features from the various embodiments shown and described may in themselves constitute authentic inventive solutions. The object underlying such authentic inventive solutions is found in the description.

In the Figures, the following elements are designated by the preceding reference numerals:
1 traveling direction
2 left rail
3 right rail
4-6 sleeper
7-10 fastening elements
11, 12 fastening elements of sleeper 6
13 position
14 point of origin
intersection
16 reference point
17 track axis
18 starting point
19 (none)
first measuring device
21 second measuring device
22 third measuring device
23 straight line a
24 further position
further position
31 switch starting point
32 switch end point
33 switch end point
34 tongue tip
35 guard rail starting point
36 guard rail end point
37 frog
38 mate sleeper
39 mid-rail sleeper
40 switch centre

FIG. 1 illustrates a potential embodiment of the inventive method. As explained above, the inventive method is characterized by the ability to be executed virtually and/or actually.

FIG. 1 shows a track with the elements which are relevant elements for the below explanation of the inventive method or for executing the inventive method. The disclosure of the inventive method is by no means limited to the presence and use of those elements that are mentioned herein by way of example. The user may use different elements of the track.

The track includes a left rail 2 and a right rail 3 as seen in traveling direction 1. Rails 2, 3 are fastened to rail 6 via fastening elements 11, 12. Rail 6 is installed, for example and therefore in a non-limiting manner, in a ballast bed. Rail 6 is thus non-relocatably mounted or immobile.

It is the object of the invention described herein to detect a position 13 at a first time by data such that position 13 can be found at a second time. The invention disclosed herein thus also includes generation of said data for a sufficient description of position 13.

A measuring device is moved on the track in traveling direction 1 using a measuring vehicle. The measuring vehicle and the measuring device are not shown in FIG. 1.

A plurality of measurement values is in general generated using the measuring device. Since the measurement values can be classified by applying the current teachings, measurement values are generated on a plurality of objects which are arranged on the track. For example, depending on the measurement are, measurement values are generated for rails 2, 3, ballast gravel and rail 6.

Depending on the measuring device used, a certain kind of measurement values is determined. When using a camera as a measuring device, for example, the color, form and size of objects can be determined. A person of skill will choose a measuring device for determining measurement values which are suitable for describing a property or properties of the objects with sufficient accuracy.

The embodiment of the inventive method shown in FIG. 1 includes the step of detecting a selected object from the plurality of objects. The measurement values may be matched with reference measurement values or a reference measuring area to select a single selected object from the plurality of objects. Further or alternatively, a measurement pattern of the measurement values may be matched with reference measurement pattern of a selected reference object to select a single selected object from the plurality of objects.

Matching the measurement values with reference measurement values may include determining a similarity measure between the selected object and the reference object. Determining the similarity measure is done by calculation using methods of current teachings, in which a similarity measure defined by a numerical value is determined as a result.

The above method steps for selecting a selected object from the plurality of objects by matching—in a broader sense—with a reference object include that the reference measurement values or the reference measuring area is/are deposited in a database. For this it is critical that the reference object be chosen such that, by matching the measurement values and the reference measurement values, a selected object is selected which is non-relocatably mounted in the space. In an advantageous manner, the reference object is deposited in the database as a non-relocatably mounted object or as an object that is non-relocatably mounted with a certain likelihood.

In FIG. 6, for example and therefore in a non-limiting manner, sleeper 6 could be a selected object. Sleeper 6 is non-relocatable in the space because of the way it is mounted. As initially mentioned, the measuring device is arranged on a rail vehicle. Due to the rail vehicle, based on its own weight or using a mechanical device, a load condition can be created in which the non-relocatable mounting of the selected object can be verified. This verification of the non-relocatable mounting, which is mentioned here by way of example and not limitation, can require the use of a measuring device to measure any potential displacement of a sleeper. The above measuring device may be used in this case in an advantageous manner.

The inventive method provides that position 13 be localized relative to sleeper 6 as a selected object having a unique property with respect to the plurality of objects. Using distance measuring devices, the vectorial distance a between position 13 and a predefined point of origin 14 of sleeper 6 is measured as a selected object.

For example, distance a can be measured as the length of a straight line 23 extending between the point of origin 14 and position 13.

Measurement of distance a may also be reduced to a distance al or the length of rail 2, on which position 13 is located by way of example in the context of discussing the embodiment of the inventive method, between sleeper 6 and position 13. This information on position 13 may include the specification that position 13 is located on the left rail 2. The length of rail 2 may be measured as a length between position 13 and an intersection 15 between a line extending through the point-shaped fastening elements 11, 12 (equaling the sleeper axis here) and rail 2. The orthogonal distance between position 13 and an axis of sleeper 6 may also be determined as a selected object for relative localization of position 13.

The inventive method is characterized by the relative localization of position 13 with respect to sleeper 6 as a selected object mentioned by way of example following objective measurement information.

A person of skill can perform the mentioned methods of determining the vectorial distance a between position 13 and the point of origin 14 or the selected object through measurement information which the skilled person determines using their knowledge in the art. The skilled person can also perform relative localization of position 13 with respect to the point of origin 14 or to the selected object through such measurement information. This is applicable with reference to the embodiment described in FIG. 1 and also to the further embodiments of the inventive method.

The above description associated with FIG. 1 includes reference to the use of the measuring device for determining measurement values which describe unique properties of sleeper 6 as a selected object. Using the measuring device, the point of origin 14 may be defined such that the point of origin 14 has unique properties with respect to the surrounding points of sleeper 6 as a selected object.

The point of origin 14 may also be defined by indicating geometrical relationships between further points of sleeper 6, which further points have unique properties. The point of origin 14 is the center of a straight line extending between the point-shaped fastening elements 11, 12. The user may define further geometrical relationships between further points.

The point of origin 14 may lie on the track central axis 16. The track central axis 17 is defined as an axis equally spaced apart from rails 2, 3.

Distance measurement can be subject to inaccuracies. The inventive method has the advantage that localization of position 13 relative to sleeper 6 as a selected object with unique properties is done by determining a relatively short distance. The exemplary embodiment shown in FIG. 1 and described above is based on the use of sleeper 6. Since the typical distance between sleepers is about 65 centimeters, the distance al to be measured in parallel with the direction of extension of a track is no greater than about 65 centimeters or, even better, no greater than about 32.5 centimeters. Due to the short distance that is also relatively short with respect to other dimensions in the track, the inaccuracies of distance measurement are negligible.

The inventive method is characterized by the relative localization of position 13 with respect to sleeper 6 as a selected object is performed merely via the presence of the sleeper 6 as a selected object on the traveling distance in traveling direction 1 from a starting point 17 and/or from a reference point 16.

Instead of the one sleeper 6 as a selected object, for example, the left fastening element 12 as seen in traveling direction 1 may be used as a selected object. Likewise, a waymark (not shown in FIG. 1) may be used. Selection of an object as a selected object is limited to the object having one or more unique properties and the object being non-relocatably mounted.

A unique property of a sleeper as a selected object may be a code, which code is linked to sleeper 6.

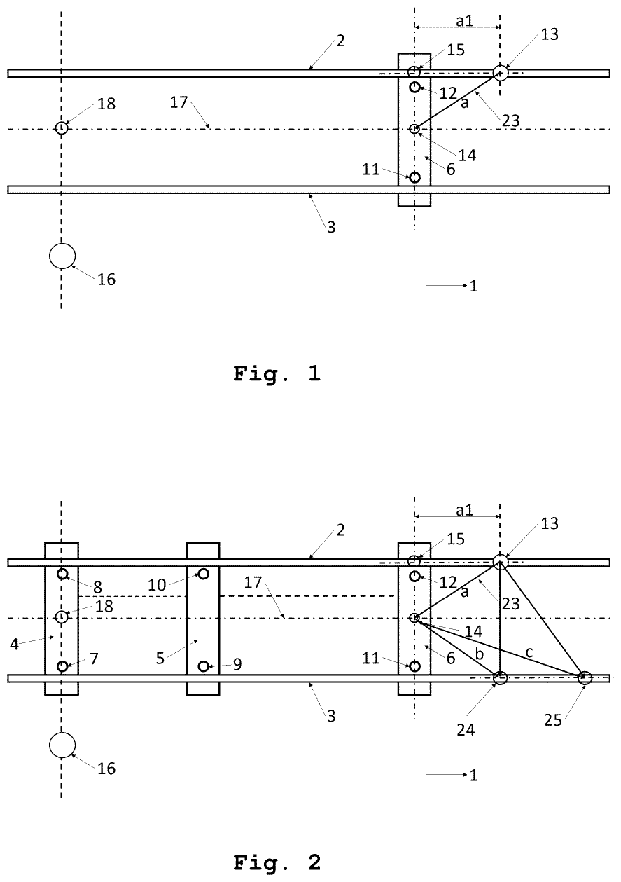

FIG. 2 illustrates a further embodiment of the inventive method for localizing position 13 on the track.

FIG. 2 shows the track with the elements which appear to be essential for explaining the inventive method. The disclosure is by no means limited to the elements shown merely by way of example in FIG. 2. The inventive method may also be applied to other elements.

The track includes a left rail 2 and a right rail 3, as seen in traveling direction 1. The rails 2, 3 are fastened to the sleepers 4, 5, 6 via fastening elements 7-12. Fastening is via two fastening elements 7-12 per sleeper 4, 5, 6.

A measuring vehicle is moved on the track in traveling direction 1 from a starting point 18. The measuring vehicle includes a measuring device which is suitable for determining measurement values via a plurality of objects on the track. To do so, the measuring area of the measuring device is targeted to the track. The user may target the measuring area to a certain area of the track to reduce the plurality of measurement values and also the plurality of measurement values.

The measuring vehicle, the measuring device and the measuring area are not shown in FIG. 2.

The measurement values describe properties of the objects. The measurement values are suitable for selecting a group of selected objects from the plurality of objects. This is done by comparing the measurement values of the objects with a reference measurement value or a reference measuring area to select selected objects from the plurality of objects. In an equivalent manner, a measurement pattern of the measurement values may be compared with a reference measurement pattern.

Essentially, the method of classifying the objects described in the figure description for FIG. 1 is applied. Other than in the method described above, not a single selected object having a unique property with respect to the plurality of objects, but a group of selected objects having at least one similar property between the selected objects and at least one unique property with respect to the plurality of objects is selected. In other words, the group of selected objects connected by a first property differs from the other objects by a second property.

Again, a similarity measure may be determined using methods of calculation, which essentially allows the technical effects described above.

Thus, when the measuring car not shown in FIG. 2 travels from starting point 18, the selected object along the traveled distance may be detected. FIG. 2 is based on the detection of sleepers 4, 5, 6 as selected objects. Detection of the selected objects allows determining a number n of sleepers in a distance traveled by the measuring vehicle from starting point 18, with n=1, 2, 3 . . . .

The number of sleepers 4, 5, 6 as selected objects may be determined up to immediately before position 13. Sleeper 6 is the last sleeper before position 13 as seen in traveling direction 1. Sleeper 6 is the third sleeper. The vectorial distance a is essentially measured in traveling direction 1.

It is also possible to determine the number of sleepers up to including the first sleeper after position 13 as seen in traveling direction 1. This would be the fourth sleeper, which is not shown in FIG. 2. The vectorial distance a is essentially measured against traveling direction 1.

Position 13 is localized relative to sleeper 6 as the last sleeper before position 13 and as a selected object. The vectorial distance a between a point of origin 14 of sleeper 6 and position 13 is determined. Reference is made to the above description regarding FIG. 1.

In FIG. 2, the relative localization of further positions 24, 25 is further shown. The relative localization of said further positions 24, 25 with respect to the point of origin is by determining a vectorial distance b or c, respectively. Said vectorial distances b, c describe the distance between the point of origin 14 and the further position 24, 25.

Determining the further position 24, 25 allows determining a track distance between the rails 2, 3 at a certain angle to the central axis 17. The distance between position 13 and the further position 25 is the distance between positions 13, 25 at an angle to the central axis 17. The distance between position 13 and the further position 24 is the distance between positions 13, 24 at a right angle. The latter distance may be the gauge.

The user may conduct said distances by applying the localization disclosed herein while the track bears a load as well as in a load-free state. The user may describe the condition of the track according to the localization disclosed via the distances.

Relative localization of the further positions 24, 25 would also be feasible in the method illustrated in FIG. 1.

The following is noted in addition to the above description regarding FIG. 1 and FIG. 2.

Then inventive method is not limited to a certain selected object or to certain selected objects such as a sleeper of fastening means or a mark. Preferably, the selected object or objects further has/have at least one unique property with respect to the other objects, which property can be described with sufficient accuracy by at least one measurement value and determined using a measuring device.

Preferably, the point of origin 14 lies on the central axis of the track.

Position 13 may be a position on a rail 2, 3, wherein the vectorial distance includes distance information which is measured in parallel with the respective rail 2, 3. Said distance information can be determined by a measuring wheel, for example. An inaccuracy of measurement over this relatively short length is negligible.

In FIG. 1 and in FIG. 2, a reference point 16 is included in addition to starting point 18, which reference point 16 is arranged adjacent to the track, for example and in a non-limiting manner. A track network typically includes a plurality of reference points, which reference points 16 are globally localized. Inclusion of at least one such reference point will now be discussed with reference to reference point 16, which may essentially be reduced to the question of the position of starting point 18 with respect to reference point 16.

The measuring vehicle may be moved on the track from a starting point 18, which lies at the intersection between the track axis 17 or the central axis of the track and a straight line which extends through reference point 16 and is oriented towards the track axis 17 at an angle. The angle may be 90 degrees, for example.

In addition to the relative localization from sleeper 6 as a selected object discussed above, the inventive method may include determining the distance from starting point 18 to sleeper 6 as a selected object.

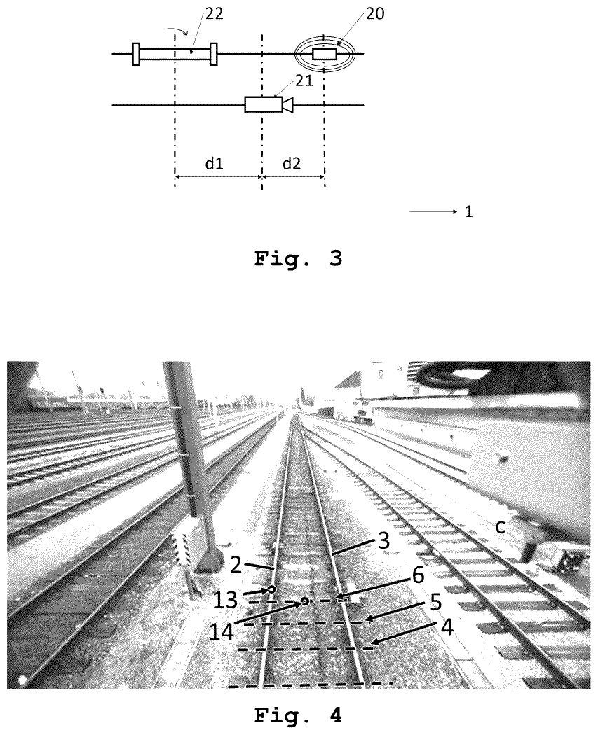

FIG. 3 shows a potential arrangement of measuring devices on a measuring vehicle. Different measuring devices may be arranged on the measuring vehicle to fulfill different measuring tasks.

The individual measuring devices are shown reduced to essentials in FIG. 3.

The measuring car may include a first measuring device 20 for detecting a discontinuity. A person of skill will choose the first measuring device depending on the type of discontinuity, to search for which the first measuring device 20 can be used. The first measuring device may be an ultrasound measuring device of prior art for detecting breaks in a rail, for example.

The measuring car includes a second measuring device 21 for determining the measurement values described above. The second measuring device 21 may be a camera with sufficient resolution, for example, which delivers images of the track from a top view. Using said images as measurement values, the presence of a sleeper 4-6 as a selected object may be determined by applying methods of prior art.

The measuring car includes a third measuring device 22 for determining the vectorial distance between the point of origin 14 and position 13, as described above. The third measuring device 22 may be a measuring wheel, for example.

When using multiple measuring devices, it is essential for the distances d1, d2 between central measuring points of the individual measuring devices 20, 21, 22 to be known. This does not mean that at least one of distances d1, d2 cannot be variable. This determination of sufficient information on distances d1, d2 may be omitted when using a single measuring device to fulfill all measuring tasks.

Examples of measuring devices are given in the description of the invention.

FIG. 4 shows a recording which is made using a camera as a measuring device. Sleepers 4-6 serve as selected objects.

Sleepers 4-6 are typically installed at a distance of about 65.0 centimeters. This pattern is easily discernible even at perspective distortion.

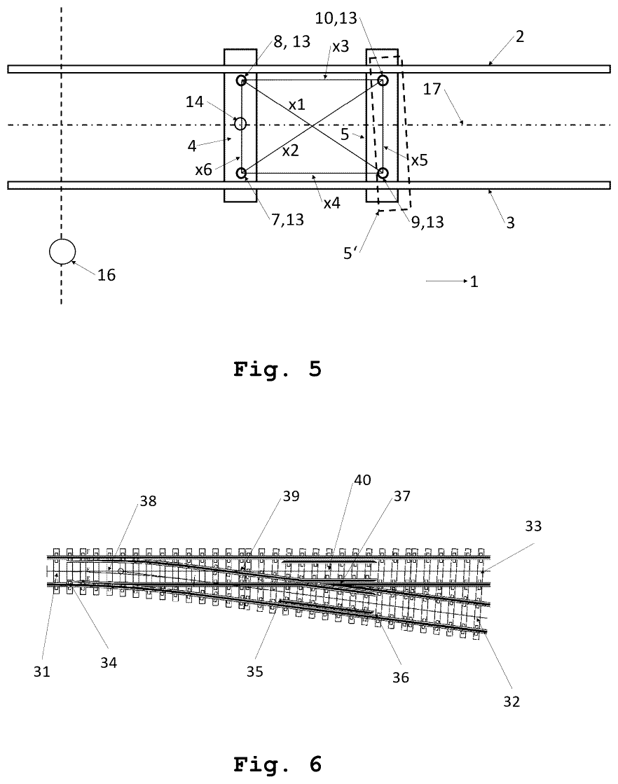

FIG. 5 shows another potential way of applying the inventive method.

Sleeper 4 as a selected object used by way of example is the n-th selected object. For example, the point-shaped fastening elements 7-10 as positions 13 may be localized relative to a point of origin 14 on sleeper 4 while determining the respective vectorial distances. Such relative localization of the point-shaped fastening elements 7-10 allows determining the given distances x1-x6 between said point-shaped fastening elements 7-10 at a first time. The user may select individual distances from the given distances or determine further distances. The method disclosed herein does not provide limitations in this respect.

Through these distances, the distance of sleepers 4, 5 as selected objects and the position of sleepers 4, 5 as selected objects with respect to one another are described in an advantageous manner. Referring to the non-limiting example shown in FIG. 5 of sleepers 4, 5 as selected objects, it may be detected through the distances whether the track has a curve in the area between sleepers 4, 5,

It is an advantage of the inventive method that the mentioned distances are localized relative to the point of origin 14. The n-th sleeper 4 as the n-th selected object is localized with a reference point 16 merely via the number n. Unless lengths between reference point 16 and point of origin 14 are additionally determined, localization of the point of origin 14 with respect to reference point 16 is done exclusively and/or with sufficient accuracy through the number n.

The user may perform relative localization of the mentioned point-shaped fastening elements 7-10 at a first time and at a second time. Thereby, the user may identify a change on the track between sleepers 4, 5 in a period between the first and second times. In this manner, for example, faults in the non-relocatable mounting of sleeper 5 may be detected.

The faulty sleeper 5′ may be found through sleeper 4, with respect to which sleeper and 5 and sleeper 5′ are localized. The faulty sleeper 5′ may easily be brought into a desired position based on the desired distances from sleeper 4.

The inventive method in its first embodiment and/or the inventive method in its second embodiment is/are able to allow localization on a switch. FIG. 6 shows an example of a switch, in which FIG. 6 the individual switch parts are each designated by a reference numeral. For example, the following switch parts may be used as a starting point or as a point of origin 14 when localizing by applying an embodiment of the inventive method, whereas the following list is by no means supposed to be exhaustive.
switch starting point 31
switch end point 32
switch end point 33
tongue tip 34
guard rail starting point 35
guard rail end point 36
frog 37
mate sleeper 38
mid-rail sleeper 39
switch center 40

If any of the exemplary points or any of the objects mentioned by way of example serves as a point of origin 14, the inventive method is able to detect the determination of such a point using the measuring device such as a camera.

1-11. (canceled)

12. A method of determining relative position information on a position on a track, comprising:
moving a measuring vehicle on the track by a distance in a traveling direction from a starting point on the track, the measuring vehicle comprises a measuring device having a measuring area targeted to the track, the measuring device is used to determine measurement values of a plurality of objects in the track structure, the measurement values describe at least one property of an object among the plurality of objects;
matching one of:
the measurement values with one of reference measurement values and a reference measuring area; and
a measurement pattern of the measurement values with a reference measurement pattern of a selected reference object to select a single selected object from the plurality of objects while determining a similarity measure between the selected object and the reference object;
storing at least one of the reference measurement values and the reference measuring area of the reference object in a database;
depositing the reference object in the database as an immobile reference object, the similarity measure being determined by calculation and configured to be indicated by a numerical value; and
indicating the position on the track by a vectorial distance between a point of origin arranged on the object and the position;
wherein one of:
the point of origin has a property determinable by the measuring device through measurement values, the property being different from first points adjacent to the point of origin; and
the point of origin is defined by geometrical conditions with respect to second points, the second points being different from points adjacent to the second points.

13. The method of claim 12, wherein the object is one of a sleeper, fastening means, and a mark.

14. The method of claim 12, wherein the point of origin lies on a central axis of the track.

15. The method of claim 12, wherein:
the position is a position on a rail; and
the vectorial distance comprises distance information which is measured in parallel with the rail.

16. The method of claim 12, wherein:
the measurement vehicle is moved on the track from a starting point;
the starting point lies at an intersection between the central axis and a straight line; and
the straight line extends through a reference point and has an orientation perpendicular to the central axis.

17. The method of claim 12, further comprising determining one of:
a first distance from the starting point to the selected object, the selected object having the similarity measure with the reference object; and
a second distance from the starting point to the n-th selected object, the n-th selected object having a further similarity measure with the reference object.

18. The method of claim 12, wherein the similarity measure lies in a similarity area defined by a user.

19. The method of claim 12, further comprising depositing in a database one of:
the at least one property of the object among the plurality of objects as determinable using the measuring device; and
properties of the last selected object of the series as determinable using the measuring device.

20. The method of claim 12, wherein the measuring device is one of a camera, a rotation scanner, and an eddy current sensor.

21. The method of claim 12, wherein the vectorial distance is determined using an odometer wheel or a camera.

22. A method for determining a relative position on a track, comprising:
moving a measuring vehicle on the track by a distance in a traveling direction from a starting point, the measuring vehicle comprising a measuring device having a measuring area targeted to the track;
determining, by the measuring device, measurement values of a plurality of objects in the track structure, the measurement values describing at least one property of an object among the objects;
matching one of:
the measurement values with one of a reference measurement value and a reference measuring area of a reference object group; and
a measurement pattern of the measurement values with a reference measurement pattern of the reference measurement values to select selected objects from the plurality of objects while determining a similarity measure between a selected object among the selected objects and the reference objects;
storing at least one of the reference measurement values and the reference measuring area of the reference object in a database;
depositing the reference object in the database as an immobile reference object, the similarity measure being determined by calculation and configured to be indicated by a numerical value, the selected objects having at least one similar property described by a measurement value;
determining a number n, with n=1, 2, 3 . . . , of the selected objects on a distance traveled from the starting point by the measuring vehicle; and
indicating the position by a vectorial distance between a point of origin and the position, the point of origin being arranged on the n-th selected object among a series of the selected objects as seen in the traveling direction;
wherein one of:
the point of origin has a property determinable by the measuring device through measurement values, the property being different from first points adjacent to the point of origin; and
the point of origin is defined by geometrical conditions with respect to second points, the second points being different from points adjacent to the second points.

23. The method of claim 22, wherein the object is one of a sleeper, fastening means, and a mark.

24. The method of claim 22, wherein the point of origin lies on a central axis of the track.

25. The method of claim 22, wherein:
the position is a position on a rail; and
the vectorial distance comprises distance information which is measured in parallel with the rail.

26. The method of claim 22, wherein:
the measurement vehicle is moved on the track from a starting point;
the starting point lies at an intersection between the central axis and a straight line; and
the straight line extends through a reference point and has an orientation perpendicular to the central axis.

27. The method of claim 22, further comprising determining one of:
a first distance from the starting point to the selected object, the selected object having the similarity measure with the reference object; and
a second distance from the starting point to the n-th selected object, the n-th selected object having a further similarity measure with the reference object.

28. The method of claim 22, wherein the similarity measure lies in a similarity area defined by a user.

29. The method of claim 22, further comprising depositing in a database one of:
the at least one property of the object among the plurality of objects as determinable using the measuring device; and
properties of the last selected object of the series as determinable using the measuring device.

30. The method of claim 22, wherein the measuring device is one of a camera, a rotation scanner, and an eddy current sensor.

31. The method of claim 22, wherein the vectorial distance is determined using an odometer wheel or a camera.
